(19) United States
(12) Patent Application Publication
(10) Pub. No.: US 2026/0330514 A1
(43) Pub. Date: Oct. 22, 2026

(54) Seller Feedback Signals

(71) Applicant: eBay Inc., San Jose, CA (US)

(72) Inventors: Yue Lu, Portland, OR (US); Vigneshram Murugan, Cumming, GA (US); Gaolin Zhang, San Jose, CA (US)

(73) Assignee: eBay Inc., San Jose, CA (US)

(21) Appl. No.: 19/182,838

(22) Filed: Apr. 18, 2025

(51) Int. Cl. G06Q 30/0282; G06F 40/279; G06F 40/40; G06Q 30/0601

(52) U.S. Cl. CPC G06Q 30/0282; G06F 40/279; G06F 40/40; G06Q 30/0625; G06Q 30/0641

(57) ABSTRACT

Seller feedback signals are described. In one or more implementations, feedback including text reviews about sellers associated with an online marketplace is obtained. For an individual seller, the feedback about the individual seller describing interactions with the individual seller on the online marketplace is aggregated; a large language model extracts keywords from the aggregated feedback about the individual seller; and the extracted keywords are categorized into predetermined categories that each summarize an aspect of interacting with individual sellers on the online marketplace. In a page of search results items listed on the online marketplace or an item listing page for a particular item listed on the online marketplace, having an item or search result that corresponds to the individual seller, a display of the search result items or item listing page presents, in association with the individual seller, feedback signals indicating the categories.

### BACKGROUND

Currently, aggregated reviews on online marketplaces are often about particular products, and they can often be found on a respective product page of the product. Some online marketplaces include reviews about sellers, which are typically found on a seller page. However, a user that wants feedback about a seller must typically navigate to a seller page to view the seller feedback, which involves extra effort such as scrolling, clicking, and reading through numerous comments line by line. This involves a series of inputs and interfaces to navigate from a search page or an item page or the like.

### SUMMARY

Unlike traditional systems that rely on simple keyword matching, which can lead to false positives and misinterpretations, the seller feedback system described herein employs natural language processing and sentiment analysis to accurately interpret the context and sentiment of aggregated seller feedback. Further, in order to ensure relevance and reliability, the system can limit use of the described techniques and also which seller feedback comments are processed to provide an improved interface with seller feedback signals. For example, the system can limit the comments processed for providing seller feedback signals to comments expressing positive feedback and comments received within a most recent time period, e.g., six months. The use of seller feedback signals may also be limited to sellers for which at least a minimum number of feedbacks have been received.

From the seller feedback comments, the seller feedback system generates intuitive, pre-defined labels or user interface elements, such as for “Fast Shipping,” “Item as Described,” and so on. These labels or interface elements provide users with a concise and accurate summary of seller performance and signal the existence of actual seller feedback. In contrast to conventional approaches, these labels are displayed on view item pages and search result pages, reducing the need for users to navigate away from those pages to seller-specific pages to assess seller reliability. By reducing such navigation to seller-specific pages, the improved interfaces reduce an amount of user input received to allow users to view seller feedback and assess seller reliability. With fewer inputs received and less inter-page navigation, the described system reduces an amount that processors of computing devices are utilized to detect and respond to those inputs and to update displays to new pages based on the detected inputs. Further, by reducing the amount that processors are utilized, power of the respective computing devices is conserved thereby extending a battery life of those computing devices. In one or more implementations, a user can hover over a label to see excerpts of actual seller feedback related to each label, offering deeper insights into the seller of an item without additional clicks.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a user interface for a seller feedback system.

FIG. 3 depicts another example of a user interface for a seller feedback system.

FIG. 4 depicts a comparative example of a user interface.

FIG. 5 depicts an example of a user interface.

FIG. 6 depicts an example of a sequence diagram for a seller feedback system.

FIG. 7 depicts another example of a sequence diagram for a seller feedback system.

FIG. 8 depicts another example of a sequence diagram for a seller feedback system.

FIG. 9 depicts a procedure in an example implementation of seller feedback signals.

FIG. 10 illustrates an example of a system that may implement various techniques described herein.

### DETAILED DESCRIPTION

### Overview

One of the most important ways for buyers and sellers to communicate in an online marketplace is seller feedback. However, comments about sellers are often not easily reached in an online marketplace and/or reaching comments particularly about sellers can require users to disengage from a current context, e.g., from an item page. Even if there is a discussion of a seller in a comment regarding an item, the discussion may be difficult to locate among numerous comments about the item. Also, it can be difficult for a buyer to understand what a particular comment means, where/how to obtain some basic knowledge about the seller, and to determine what a summarized evaluation, such as “100% positive,” actually means. Some ecommerce platforms involve a diverse array of sellers offering items and the condition and authenticity of those items may vary widely. Currently, a buyer that wants to obtain feedback about a seller of an item must navigate away from an item page or dig deep into item comments. These extra navigation steps involve additional user inputs and can break a current context of user interaction with the user interface. Even when the buyer has navigated to the seller page, the seller page may indicate an overall score for the seller, followed by many different text reviews which must be reviewed line-by-line.

To address these and other issues, a seller feedback system provides an improved user interface that allows a user to easily and quickly review a reputation of a seller of an item in which the user demonstrates interest. An interactive and intuitive user interface provides rapid and detailed insight into the overall seller reputation based on feedback and is seamlessly integrated without requiring additional navigation.

Broadly, a seller can be considered one component of the entire experience surrounding product quality and satisfaction, for example, whether the seller's products are easy to return, whether the seller ships products in a short time frame, or whether the seller communicates clearly and accurately. In accordance with the described techniques, seller feedback received in relation to a seller's products is aggregated for the seller. The aggregated feedback is categorized into keywords which are extracted from text reviews comprising the feedback using artificial intelligence to provide at-a-glance understanding of potentially large quantities of feedback. An improved interactive and intuitive user interface provides access to detailed comments which reveal relevant insights into seller behavior without additional navigation. Further, an improved user interface maintains the current context within the user interface. Moreover, the seller feedback system builds trust of a seller based on experiences that are important to purchasers, provides insight into what aspects the seller excels in relative to other sellers, and exposes specific information that informs users what to expect from the seller based on reviews of the seller.

In contrast to conventional approaches, the interactive label elements described herein which provide such intuitive feedback can be displayed on item pages and search result pages, eliminating the need for a user seeking feedback about a seller to navigate away from those pages to a seller-specific page to assess seller reliability or to dig deep into comments about items. By eliminating such navigation to seller-specific pages, the improved interfaces reduce an amount of user input needed to allow users to view seller feedback while reviewing various other details about items, e.g., in search results pages or item specific pages. With fewer inputs and reduced inter-page navigation, the described system reduces an amount that processors of computing devices are utilized to detect and respond to those inputs and to update displays to new pages based on the detected inputs. Further, by reducing the amount that the processors are utilized, power of the respective computing devices is conserved thereby extending the battery life of those computing devices.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

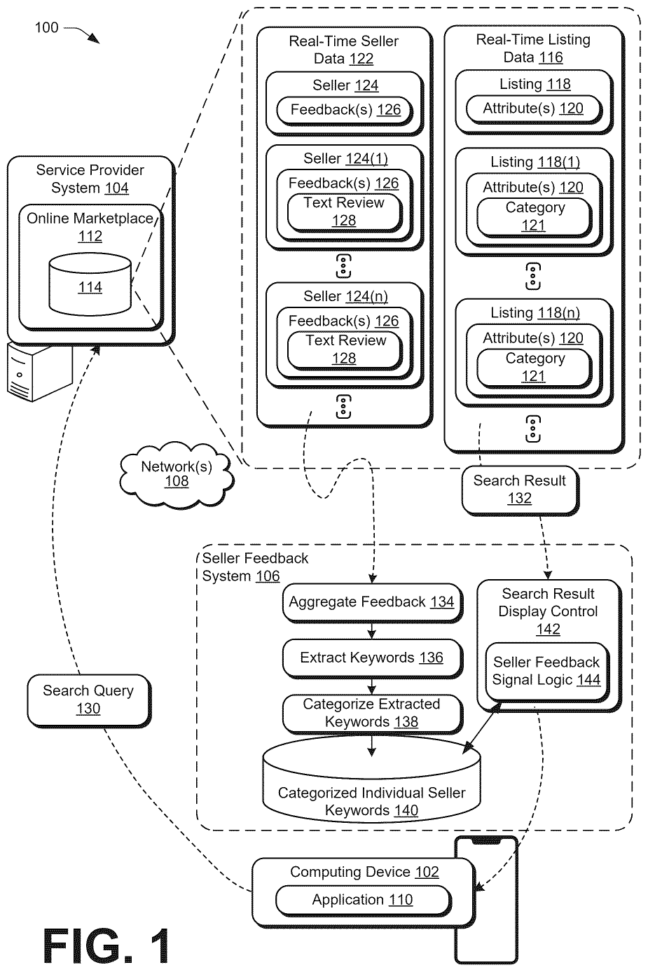

FIG. 1 is an illustration of an environment 100 in an example implementation that is operable to employ techniques described herein. The environment 100 includes a computing device 102, a service provider system 104, and a seller feedback system 106. In one or more implementations, the computing device 102, the service provider system 104, and the seller feedback system 106 are communicatively coupled, one to another, via network(s) 108. One example of the network(s) 108 is the Internet, although one or more of the computing device 102, the service provider system 104, and the seller feedback system 106 may be communicatively coupled using one or more different connections or different networks in various implementations.

Although the seller feedback system 106 is depicted in the environment 100 as being separate from the computing device 102 and the service provider system 104, in one or more implementations, an entirety or various portions of the seller feedback system 106 are implemented at or by the computing device 102 and/or the service provider system 104. In at least one implementation, for example, at least a portion of the seller feedback system 106 is implemented by an application 110 of the computing device 102 and/or using various resources of the computing device 102, such as hardware resources, an operating system, firmware, and so forth. Alternatively or additionally, at least a portion of the seller feedback system 106 is implemented by resources (e.g., server-based storage, processing, and so on) of the service provider system 104. Alternatively or additionally, at least a portion of the seller feedback system 106 is implemented using a third-party service, such as a web services platform that provides one or more hardware and/or other computing resources to support provision of services by web service providers.

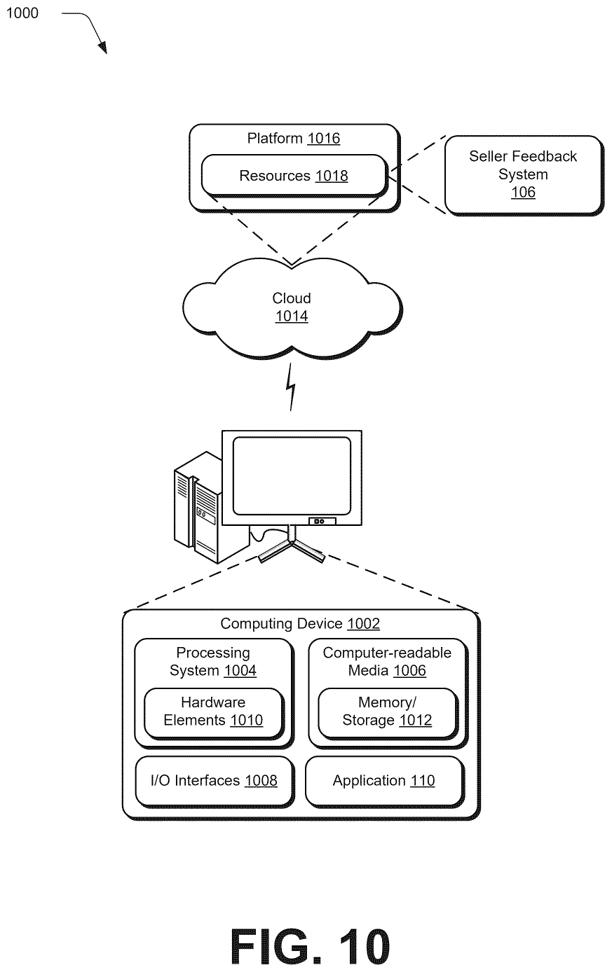

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 10.

In at least one implementation, the application 110 supports communication of data across the network(s) 108, such as between the computing device 102 and the service provider system 104 and/or between the computing device 102 and the seller feedback system 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) across the network(s) 108 to one or more computing devices, including to the computing device 102. For example, the online marketplace 112 may generate listings for items for sale and expose those listings to computing devices, such that users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the environment 100, the online marketplace 112 includes storage device 114, which is depicted maintaining real-time listing data 116. The real-time listing data 116 includes listings of the online marketplace 112, one example of which is listing 118. Other examples of such listings include listing 118(1) and listing 118(n), where ‘n’ represents any integer number greater than or equal to 2. The real-time listing data 116 is depicted with ellipses to indicate the existence of more listings than the listing 118, the listing 118(1), and the listing 118(n). A category 121 of the item in the listing 118 may be an attribute 120 of the listing 118.

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed in to such an account or tracked as a user with an account.

In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or agents).

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to purchase one or more items from the listings of the online marketplace 112.

A user that is a seller, for instance, may interact with one or more user interfaces of the online marketplace 112 (e.g., output via the application 110) to provide information about one or more items which the user is causing to be listed on the online marketplace 112. Such user interfaces may include prompts that instruct, or guide, users that are sellers to provide various information about items being listed. Examples of information that such interfaces prompt sellers for and that those users provide include but are not limited a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few. One or more portions of such information may be referred to herein as “attributes” of the listing. For example, a title of the listing may be an attribute of the listing, a description of the item being listed may be an attribute of the listing, one or more images uploaded or selected for the listing may be one or more attributes of the listing, and so on.

In accordance with the described techniques, the storage device 114 of the online marketplace 112 is also depicted maintaining real-time seller data 122. The real-time seller data 122 includes data about the sellers that correspond to the listings of the online marketplace 112, one example of which is seller 124. Other examples of such sellers include sellers 124(1) and seller 124(n), where ‘n’ represents any integer number greater than or equal to 2. The real-time seller data 122 is depicted with ellipses to indicate the potential existence of more sellers than the seller 124, the seller 124(1), and the sellers 124(n). The real-time seller data for each seller 124 may further include seller information such as seller name, seller contact information, seller-specific page of the online marketplace 112, details about look and feel of the seller-specific page (e.g., one or more style sheets, configuration data (files), and so on), a seller identifier which is unique to each seller within the real-time seller data 122, and one or more feedback(s) 126. In at least one scenario, a text review 128 of the seller 124 may be included in the feedback(s) 126. The feedback(s) 126 and the text review 128 may be entered by users providing evaluations and observations regarding their interaction with the seller 124, such as in connection with purchasing an item through interaction with a listing 118 of the seller 124. As noted above, the storage device 114 is configurable in any of a variety of ways to store data, including the real-time seller data 122.

As discussed above and below, the described techniques provide information about sellers of items on an online marketplace in improved ways relative to conventional techniques. In one or more scenarios, a user may interact with any of a variety of interfaces of the online marketplace 112 (e.g., output via the application 110) to obtain information about at least one listing 118 of the online marketplace 112. For example, a user of the application 110 may issue a search query 130 (e.g., a string of text, a voice query, and/or one or more images, etc.), to which the online marketplace 112 responds with a search result 132 that includes at least one listing 118. In accordance with the described techniques, seller feedback signals may be provided along with one or more of the listings in the search result 132 (e.g., each listing in the search result 132) to quickly inform the user about the respective sellers of the items in the search results. The seller feedback system 106 may incorporate such information into a user interface of the online marketplace 112 in accordance with the following discussion.

In one or more implementations, the seller feedback system 106 includes logic, as discussed below, to aggregate feedback 134, extract keywords 136, and categorize extracted keywords 138, which may be stored in association with individual sellers as represented by categorized individual seller keywords 140. The seller feedback system 106 may also include logic for a search result display control 142 which instructs the application 110 specifically as to control of the display to allow user interaction with seller feedback signals provided by seller feedback signal logic 144. The seller feedback signal logic 144 obtains categorized individual seller keywords 140 which correspond to the individual sellers which correspond to the items included in the search result 132, and the obtained individual seller keywords are provided as seller feedback signals.

Together with the search result 132, or separately, the online marketplace 112 can cause the computing device 102 to display the seller feedback signals provided by the seller feedback signal logic 144. The seller feedback signals which are displayed correspond to text reviews of user interactions with the individual seller regarding one or more of the seller's listings.

Having considered an example of an environment, consider now a discussion of some example details of the techniques for seller feedback signals in accordance with one or more implementations.

### Seller Feedback Signals Implementation Details

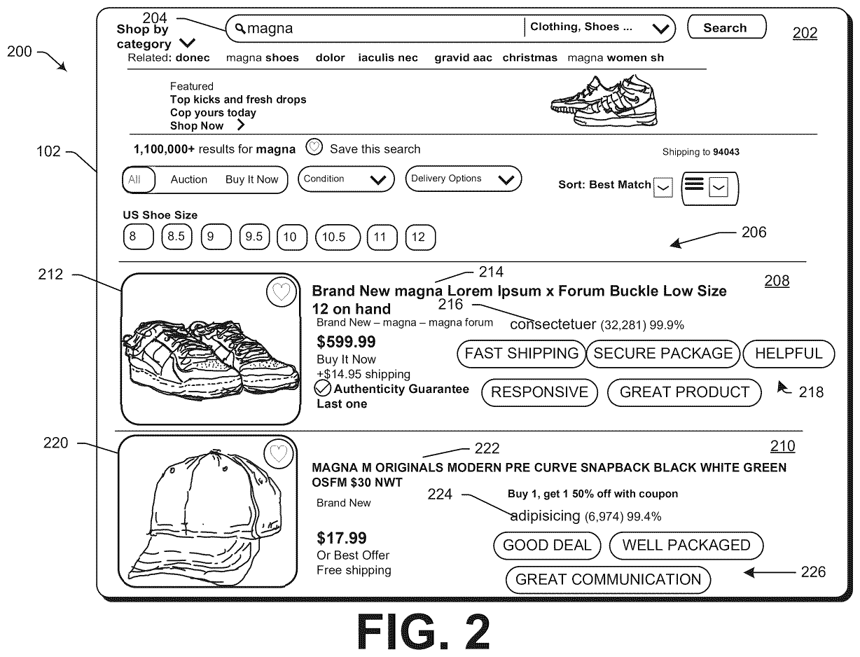

FIG. 2 depicts an example 200 of a user interface for a seller feedback system.

The example 200 includes a search results user interface 202, such as may be displayed at the computing device 102. The search results user interface 202 includes a variety of interactive user interface elements with which a user can interact to provide information about an item that the user would like to locate in the online marketplace 112. As noted above, the online marketplace 112 receives input via such interactive elements to specify information to be searched regarding a listing.

In the example 200, the user may interact with a search input 204 to specify the search parameters, such as search term(s) which are input and other optional search parameters, and to receive the search result as illustrated in the search results user interface 202. The user may interact with the search results user interface 202 to select one or more of the listings returned as the list 206 of search results. In the present example, the list 206 of search results includes at least one listing 118, represented by a first listing card 208 and a second listing card 210. The first listing card 208 includes, for example, an image 212 of an item which is offered, title and description information 214, seller information 216 for an individual seller that offers the item in the first listing card 208, and seller feedback signals 218 indicating the existence of summaries of feedback(s) 126 specifically corresponding to the individual seller indicated in the seller information 216. The second listing card 210 includes, for example, an image 220 of an item which is offered, title and description information 222, seller information 224 indicating a seller that offers the item in the second listing card 210, and seller feedback signals 226.

The seller feedback signals 218, 226 categorize feedback(s) 126 received by the online marketplace 112 as corresponding to the respective individual seller corresponding to the first listing card 208 and the second listing card 210. The seller feedback signals 218, 226 indicate the availability of informative summaries of and/or quotes from text reviews 128 in the feedback(s) 126 specifically corresponding to the individual seller indicated in the seller information 216, 224. Because the seller feedback signals 218, 226 are based on the text reviews 128 in feedback(s) 126 that are specific to the different individual sellers respectively indicated in the seller information 216, 224, the seller feedback signals 218, 226 can be different from seller to seller depending on the content of the text reviews 128 corresponding thereto.

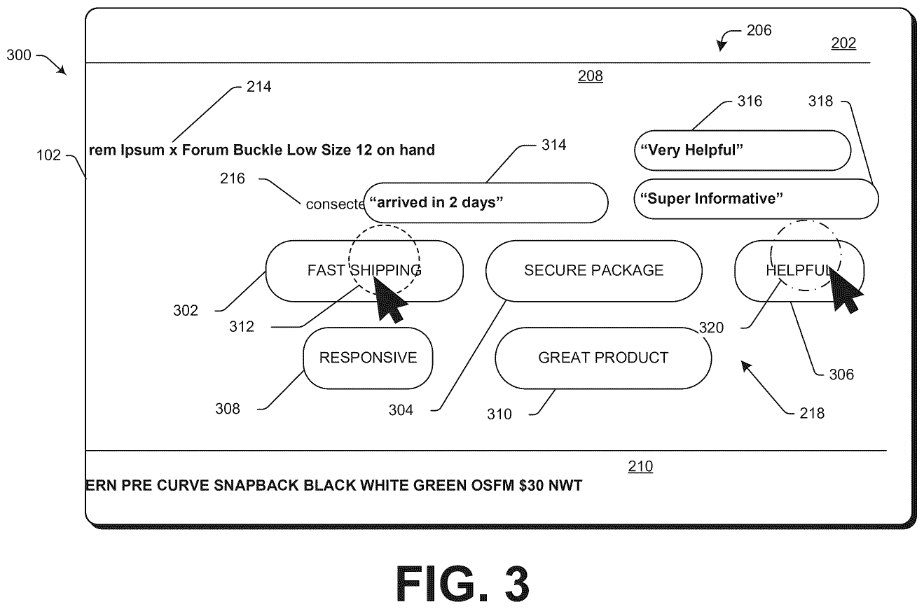

FIG. 3 depicts another example 300 of a user interface for a seller feedback system.

For ease of illustration, the example 300 includes a closeup of the first listing card 208 in the search results user interface 202 provided by the computing device 102. The seller feedback signals 218 include predetermined category information 302, 304, 306, 308, 310. Each predetermined category information 302, 304, 306, 308, 310 in the seller feedback signals 218 is indicative of an aspect of interacting with the individual seller indicated in the seller information 216, based on the feedback(s) 126 for that seller. The predetermined category information 302, 304, 306, 308, 310 in the seller feedback signals 218 indicates the availability of extracted keyword information 314, 316, 318 which provide summaries of and/or quotes from the text reviews 128, categorized as that aspect of interaction with the individual seller.

In response to the user performing an input or selection of one or more feedback signals, such as in relation to the predetermined category information 302, such as by performing an input 312 (e.g., a hover, tap, or click) on the predetermined category information 302, the extracted keyword information 314 corresponding to the predetermined category information 302 is displayed on the user interface 202. For example, the extracted keyword information 314 may be displayed adjacent to the predetermined category information 302 which is selected, such as in a popup triggered in response to the user selection. The extracted keyword information 314 displays keywords which were extracted from the feedback(s) 126 and were determined to be included in the predetermined category (e.g., “Fast Shipping”), as further described herein.

In order to provide the predetermined category information and the extracted keyword information as the seller feedback signals 218, feedback(s) 126, including text reviews 128, about the individual seller describing interaction with the individual seller on the online marketplace 112 are aggregated. In one or more implementations, keywords are extracted from the aggregated feedback about the individual seller using a large language model. The extracted keywords are categorized into predetermined categories that each summarize an aspect of interacting with the individual seller in the online marketplace 112. In this example, for instance, text descriptions which are the summarized aspects include “arrived in 2 days”, “Very Helpful”, and “Super Informative” which are included somewhere in the text reviews 128 of the feedback(s) 126 for the individual seller. The feedback(s) 126 for the individual seller are provided to a large language model for the individual seller, and “arrived in 2 days”, “Very Helpful”, and “Super Informative” are determined to be informative keywords about the seller and are extracted from the aggregated feedback for the individual seller.

Further, the extracted keywords “arrived in 2 days”, “Very Helpful”, “Super Informative”, and any other keywords that are extracted are categorized into predetermined categories that summarize aspects of interacting with the seller. The predetermined categories by way of example include “fast shipping”, “secure package”, “helpful”, “responsive”, and “great product”, as shown in the predetermined category information 302, 304, 306, 308. In implementations, a variety of predetermined categories may be provided which rate the seller's interaction with a user. Additionally, more or fewer predetermined categories may be presented, e.g., more or fewer than the five shown in the example 300. An individual seller may have all or fewer than all of the predetermined categories.

In the example of FIG. 3, extracted keywords “arrived in 2 days” was categorized by the seller feedback system 106 as corresponding to the predetermined category information 302 “FAST SHIPPING”, and the extracted keywords “Very Helpful” and “Super Informative” are categorized as corresponding to the predetermined category information 306 “HELPFUL”. The extracted keyword information 314 providing the text description “arrived in 2 days” is displayed in response to the user selecting the predetermined category information 302 “FAST SHIPPING” via input 312, so that the user quickly has access to a snippet from an actual text review about the seller without requiring the user to navigate away from the first listing card 208 on the search results user interface 202 and browse through numerous text reviews.

Similarly, the extracted keyword information 316, 318, providing the text descriptions “Very Helpful” and “Super Informative” are displayed in response to the user selecting the predetermined category information 306 “HELPFUL” via input 320, examples of which include but are not limited to a hover, a tap, a partial tap, a click, and a double click, to name just a few. In variations, one, two, or more of the extracted keywords may be provided in response to receiving input in relation to one of the predetermined category information 302, 304, 306, 308, 310.

The “hover-over” feature improves the user interface relative to conventional user interfaces by providing quick access to more detailed seller feedback information than the labels alone. When a user hovers over one of the predetermined category information labels (e.g., 302, 304, 306, 308, 310), for instance, the system may display a popup or tooltip containing extracted keyword information (e.g., 314, 316, 318) related to that category. Certainly, the input triggering display of such a popup or tooltip containing the extracted keyword information may be different from a hover input in variations.

In one or more implementations, the extracted keyword information is directly derived from actual seller feedback comments that match the semantic meaning of the predetermined category label. When a user hovers over a label such as “FAST SHIPPING,” the system displays extracted phrases like “arrived in 2 days” that were identified by the large language model as being semantically related to that specific category of seller performance. This feature allows users to see actual excerpts from seller feedback comments without leaving the current page or performing additional clicks.

Consider again the just-discussed example where, if a user hovers over the “FAST SHIPPING” label, they may be shown comments like “arrived in 2 days” in a small popup window. Similarly, hovering over the “HELPFUL” label might reveal comments such as “Very Helpful” and “Super Informative,” which are excerpts from actual seller feedback comments. This interactive element provides users with a more immersive and efficient shopping experience, as they can quickly gauge seller performance across various aspects without the need to navigate to separate pages or scroll through review sections. The hover-over feature may also display the frequency or recency of such feedback, giving users a more comprehensive understanding of the seller's performance over time.

In accordance with the described techniques, the seller feedback signals 218 are derived from text reviews in feedbacks of the seller without being specific to the item in the first listing card 208. The seller feedback signals are displayed on the search results user interface 202 without requiring the user to navigate away from the list 206 of search results.

Selecting other ones of the predetermined category information 304, 308, 310 in the seller feedback signals 218 will similarly bring up the extracted keywords which were extracted from the text review, and which correspond to the individual seller.

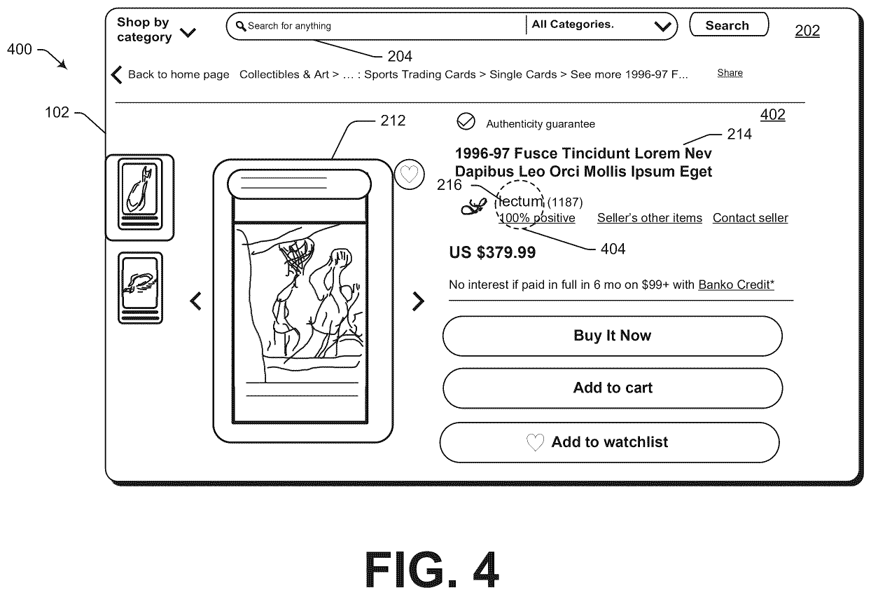

FIG. 4 depicts a comparative example 400 of a user interface.

In the comparative example 400 an item listing page 402 displays the image 212 of the item, the item title and description information 214, the seller information 216 corresponding to the item and conventional feedback information 404. The conventional feedback information 404 in the present example indicates “100% positive,” though it is unclear as to how that relates to any aspect of the seller or any buyer experience. Conventionally, feedback regarding the individual seller may be accessed from the item listing page 402 or a page of search results by a selection of the conventional feedback information 404 which causes the user interface 202 to traverse to a display of a seller page.

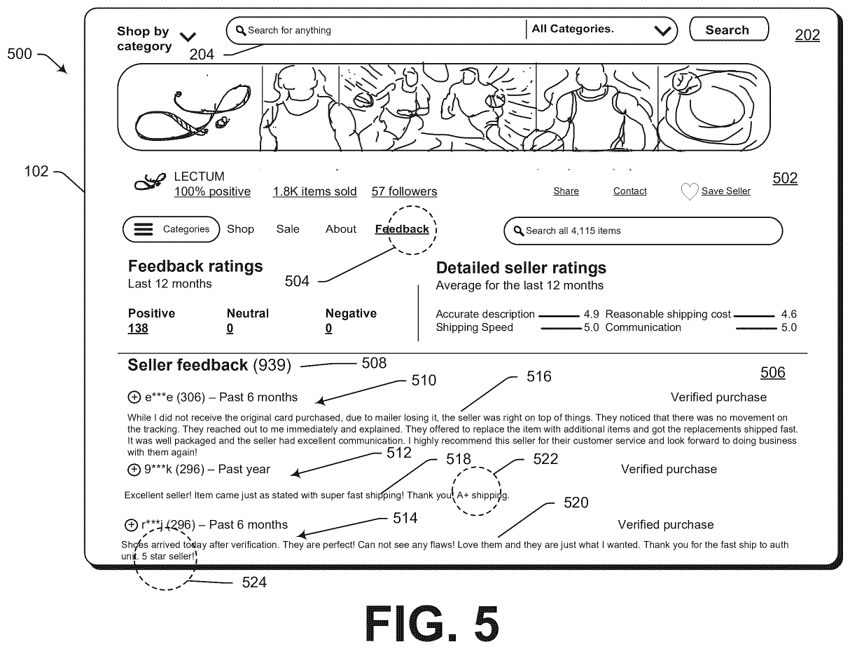

FIG. 5 depicts an example 500 of a user interface.

In the example, a seller page 502 provides a seller-specific page that displays information about the seller. By selecting a feedback tab 504, the seller page 502 displays a seller feedback list 506. The seller feedback list 506 indicates a count 508 of individual feedback entries, and lists individual feedback entries, here represented by feedback entries 510, 512, 514. Each of the feedback entries 510, 512, 514 may include, among other things, a text review 516, 518, 520 that each includes a textual comment.

Inside the text review 518, 520, may be one or more predetermined rating-text-patterns 522, 524, as some reviewers are known to provide text patterns as a shorthand for a description. In the present example, the predetermined rating-text-patterns 522, 524 are “A+” and “5 star”.

The feedback entries 510, 512, 514 are stored as the text review 128 in the feedback(s) 126 for the seller 124 in the real-time seller data 122, at the online marketplace 112.

Scrolling through, for example, the nine hundred and thirty-nine instances of the feedback entries 510, 512, 514 associated with the individual seller in this example to locate information of interest to a user is time-consuming and frustrating. This process is avoided by use of the seller feedback system 106.

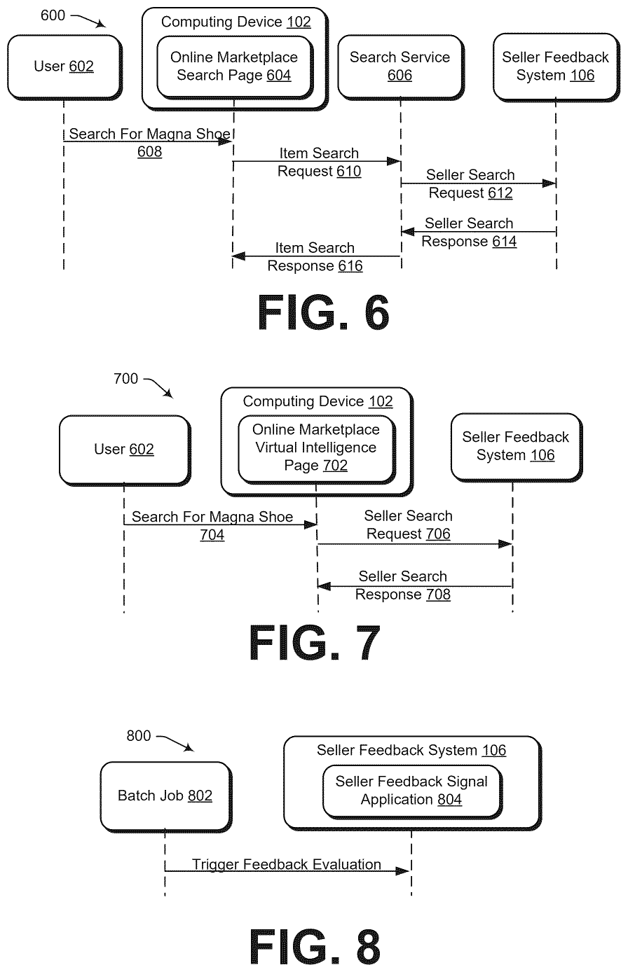

FIG. 6 depicts an example of a sequence diagram 600 for a seller feedback system.

The sequence diagram 600 illustrates a sequence between a user 602, an online marketplace search page 604, a search service 606, and the seller feedback system 106. The user 602 initiates a search 608, in this case for an item with search terms “magna shoe”, at the online marketplace search page 604 executing on the computing device 102. The online marketplace search page 604 communicates to the search service 606 an item search request 610 for the item. The search service 606 determines one or more seller(s) associated with the item(s) responsive to the search terms and communicates to the seller feedback system 106 a seller search request 612 indicating one or more associated seller(s) to the seller feedback system 106. For example, the seller search request 612 includes an index by seller identifier. The seller feedback system 106 determines the seller feedback signals corresponding to the seller, and communicates to the search service 606 a seller search response 614 that includes the seller feedback signals determined to correspond to the seller, which may be indexed by seller identifier. The search service 606 communicates to the online marketplace search page 604 an item search response 616, which includes both items responsive to the search terms and the seller feedback signals corresponding to the seller(s) of those items, for example, indexed by seller identifier. The online marketplace search page 604 can provide a display showing not only the search result(s) or the item listing page but also presenting the seller feedback signals for the sellers listed in the search result(s) or the item listing page, in accordance with techniques described above.

FIG. 7 depicts another example of a sequence diagram 700 for a seller feedback system.

The sequence diagram 700 illustrates a sequence between the user 602, an online marketplace virtual intelligence page 702, and the seller feedback system 106. The user 602 initiates a search 704, again for an item with search terms “magna shoe”, at the online marketplace virtual intelligence page 702 executing on the computing device 102. The online marketplace virtual intelligence page 702 determines items responsive for the search terms, determines sellers associated with the responsive items, and communicates to the seller feedback system 106 a seller search request 706 indicating one or more associated seller(s) to the seller feedback system 106, for example, indexed by seller identifier. The seller feedback system 106 determines the seller feedback signals corresponding to the seller, and communicates to the search service 606 a seller search response 708 that includes the seller feedback signals determined to correspond to the seller, which may be indexed by seller identifier. The online marketplace virtual intelligence page 702 provides a display showing not only the search result(s) or the item listing page but also presenting the seller feedback signals for the sellers listed in the search result(s) or the item listing page, in accordance with techniques described above.

FIG. 8 depicts another example of a sequence diagram 800 for a seller feedback system.

The sequence diagram 800 illustrates a batch job 802 for the seller feedback system 106 to preprocess the seller feedback signals at a seller feedback signal application 804. For each seller identifier based on predetermined criteria, the batch job 802 calls the seller feedback signal application 804 to trigger a feedback evaluation and to store the results on a database such as the categorized individual seller keywords 140 and within a cache such as at the computing device. The batch job 802 executes on a periodic basis, such as daily at a quiet time for example, midnight. The batch job 802 can review the real-time seller data 122 for the latest information and can update the database.

Having discussed exemplary details of seller feedback signals, consider now some examples of procedures to illustrate additional aspects of the techniques.

### Example Procedures

This section describes examples of procedures for seller feedback signals. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

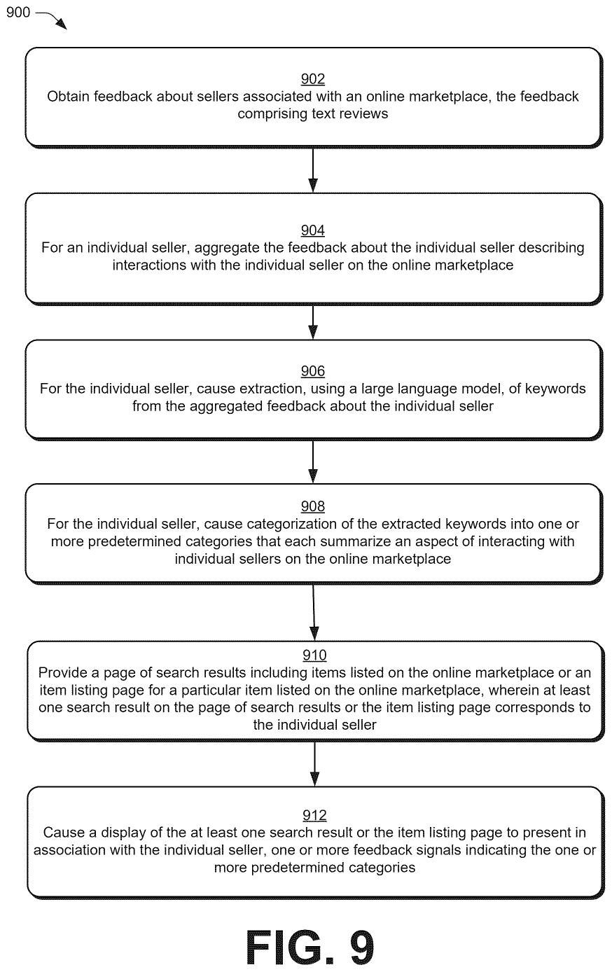

FIG. 9 depicts a procedure 900 in an example implementation of seller feedback signals.

Feedback about sellers associated with an online marketplace is obtained (block 902). The feedback comprises text review. By way of example, the seller feedback system 106 receives feedback 126 about sellers 124 obtained from the real-time seller data 122, which includes the text review 128 in the feedback(s) 126 for seller 124(1) to seller 124(n). The feedback 126 about sellers could be provided on a periodic basis such as a batch basis, and/or could be provided as text review 128 is added or updated to the feedback(s) 126. Prior to displaying the feedback about sellers, the feedback about sellers may be limited to those feedback(s) 126 which satisfy predetermined eligibility standards, such as including only positive feedback and omitting negative and neutral feedback, including only feedback which is provided in a defined recency threshold or date range such as less than 2 years old, omitting feedback if the seller is ineligible such as being too new, omitting feedback if a total number of feedbacks are too few to be informative such as a threshold of one hundred feedbacks (or some other number), and combinations, modifications and variations thereof.

For an individual seller, the feedback(s) 126 about the individual seller, which includes text describing interactions with the individual seller on the online marketplace 112, is aggregated (block 904). By way of example, the seller feedback system 106 receives the feedback 126 about sellers, which may be, for example, indexed based on a seller identifier. The logic to aggregate feedback 134 aggregates the feedback 126 about sellers to each individual seller, for example based on seller identifier.

The logic to aggregate feedback 134 may apply a recency threshold when aggregating feedback for individual sellers, which can provide several advantages compared to aggregating all available feedback without time constraints. By focusing on more recent feedback, the seller feedback system 106 may generate seller feedback signals that are more reflective of a seller's current performance and practices. This approach may be particularly beneficial in dynamic online marketplaces where seller behaviors and service quality can evolve over time.

When applying a recency threshold, the logic to aggregate feedback 134 may prioritize feedback received within a specified time frame, by utilizing a threshold such as the past six months or one year. This can result in a more focused and relevant set of feedback data for analysis by the system. In contrast, aggregating feedback without a recency threshold may include older comments that no longer accurately represent a seller's current performance. By emphasizing recent feedback, the system provides users with more up-to-date and accurate representation of seller reliability and service quality.

Further, by focusing on recent, relevant feedback, the seller feedback system 106 reduces the computational resources required for processing and analyzing seller feedback. This is because the seller feedback system 106 may not need to process all feedback across a user's entire history as a seller. Instead, the recency threshold imposes a limit on what data is processed, and potentially how long data needs to be maintained in storage devices which enable quick access to the data. This can lead to faster response times and more efficient use of system resources, particularly when dealing with sellers who have extensive feedback histories. Additionally, by presenting users with more current and relevant seller feedback signals, the system may enhance the user experience by providing more actionable information for decision-making without requiring users to navigate away from search results or item pages.

For the individual seller, keywords are extracted from the aggregated feedback about the individual seller, using a large language model (block 906). By way of example, the aggregated feedback about the individual seller, wherein each of the feedback 126(s) includes the text review 128, is provided to the large language model to execute logic to extract keywords 136 from the text review 128. The large language model to extract keywords 136 further summarizes the feedback about a particular seller. The large language model can be provided with prompts that further guide the model as to concepts to be considered a keyword to be extracted from the text.

Various types of large language models may be employed for extracting keywords from aggregated seller feedback. In one or more implementations, for instance, the large language model may include or be implemented as a generative pre-trained transformer, an artificial neural network used in natural language processing by computing devices. Such a model is implemented based on the transformer deep learning architecture and is pre-trained on large data sets of unlabeled text (e.g., the “Pile”) to generate novel human-like content. In one or more implementations, such a large language model may be specialized for use by the online marketplace 112 through fine tuning the model with the online marketplace 112's data (or a portion thereof). Alternatively or additionally, the large language model may include or be implemented as a masked language model or “MLM,” a type of self-supervised learning model used in natural language processing to train language models. Masked language models randomly mask or hide certain words in an input sequence and are trained to predict those masked words based on a surrounding context. Alternatively or additionally, the large language model is or includes a multi-modal language model, capable of incorporating non-textual modalities, such as images, audio, or video. Multi-modal large language models may be trained to generate textual outputs based on non-textual inputs (e.g., image to text) and/or trained to generate non-textural output based on textual input (e.g., text to image). Additionally or alternatively, the described techniques may utilize one or more large language model agents. Certainly a variety of types of large language models and/or architectures which utilize one or more large language models (e.g., LLM agents) may be utilized in accordance with the described techniques.

In at least one implementation, the seller feedback system 106 employs an LLM or LLM agent that utilizes one or more natural language processing (NLP) techniques and sentiment analysis to accurately interpret the context and sentiment of feedback comments. Unlike traditional simple keyword matching, which may lead to false positives and misinterpretations, an LLM can understand nuanced language, sarcasm, and context-dependent meanings. By way of example, a phrase like “great product, if you like wasting money” may be misinterpreted as positive feedback by simple keyword matching, but an LLM may correctly identify the sarcastic tone and negative sentiment. Additionally, the LLM may recognize and appropriately categorize colloquialisms, idiomatic expressions, and domain-specific terminology that might be misunderstood or overlooked by simpler text analysis methods. This sophisticated analysis may result in more accurate and meaningful categorization of seller feedback, potentially improving the relevance and reliability of the seller feedback signals presented to users.

For the individual seller, the extracted keywords are categorized into one or more predetermined categories that each summarize an aspect of interacting with individual sellers on the online marketplace (block 908). By way of example, the seller feedback system 106 executes logic to categorize the extracted keywords which are extracted by the logic to extract keywords 136. The extracted keywords as categorized retain their association with the individual seller, for example, by retaining the seller identifier information. The predetermined categories can be for example, fast shipping or great service, as may be determined from time to time. The extracted keywords that have been categorized are stored, for example, on the database such as the categorized individual seller keywords 140, which stores the keywords (which were extracted from the text review in the feedback) by the predetermined categories into which the keywords call, all in association with the individual seller such as by being indexed by seller identifier. In at least one implementation, as some reviewers are known to provide text patterns as a short hand for a description, for example, “A+” and “5 star”, the text reviews that have the predetermined rating-text-patterns 522, 524 are interpreted as being a positive review corresponding to at least one of the predetermined categories.

A page of search results including items listed on the online marketplace or an item listing page for a particular item listed on the online marketplace is provided, wherein at least one search result on the page of search results or the item listing page corresponds to the individual seller (block 910). By way of example, the application 110 issues a search request, exemplified as the search query 130 to the online marketplace 112, to which the online marketplace 112 may respond with search result 132, which may include at least one listing 118 responsive to the search query 130, provided to the seller feedback signal display control. The seller feedback signal logic 144 obtains categorized individual seller keywords from the database of the categorized individual seller keywords 140 that correspond to the seller identifiers indicated in the search result 132. The search result display control 142 instructs the application 110 specifically as to control of the display to allow user interaction with the seller feedback signals 218, 226 indicating the predetermined categories corresponding to the individual sellers identified in the listing returned in the search result 132.

A display of the at least one search result or the item listing page is caused to be presented in association with the individual seller and one or more feedback signals indicating the one or more predetermined categories (block 912). By way of example, the search result display control 142 defines behaviors for presentation and interaction (along with responses to user inputs) with the seller feedback signals 218, 226, and defines how and/or when the categorized individual seller keywords are displayed in response to user inputs.

Having described examples of procedures in accordance with one or more implementations, consider now an example of a system and device that can be utilized to implement the various techniques described herein.

### Example System and Device

FIG. 10 illustrates an example of a system generally at 1000 that includes an example of a computing device 1002 that is representative of one or more computing systems and/or devices that may implement the various techniques described herein. This is illustrated through inclusion of the application 110 and the seller feedback system 106. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more input/output interface(s) 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random-access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.” “Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

In some aspects, the techniques described herein relate to a computer-implemented method including: obtaining feedback about a plurality of sellers associated with an online marketplace, the feedback including text reviews; for an individual seller of the plurality of sellers: aggregating the feedback about the individual seller describing interactions with the individual seller on the online marketplace; causing extraction, using a large language model, of keywords from the aggregated feedback about the individual seller; and causing categorization of the extracted keywords into one or more predetermined categories that each summarize an aspect of interacting with individual sellers on the online marketplace; providing, to a computing device, a page of search results including a plurality of items listed on the online marketplace or an item listing page for a particular item listed on the online marketplace, wherein at least one search result on the page of search results or the item listing page corresponds to the individual seller; and causing a display of the at least one search result or the item listing page to present, at the computing device and in association with the individual seller, one or more feedback signals indicating the one or more predetermined categories.

In some aspects, the techniques described herein relate to a computer-implemented method, further including causing the computing device to respond to a selection of the one or more feedback signals by providing on the display the extracted keywords corresponding to the selected one or more feedback signals for the individual seller.

In some aspects, the techniques described herein relate to a computer-implemented method, further including: summarizing the extracted keywords respectively into the predetermined categories; and causing the computing device to respond to a selection of the one or more feedback signals by providing on the display the predetermined categories corresponding to the selected one or more feedback signals for the individual seller.

In some aspects, the techniques described herein relate to a computer-implemented method, wherein causing extraction and causing categorization include providing the aggregated feedback for the individual seller and the one or more predetermined categories for which the individual seller is to be rated based on the aggregated feedback to the large language model which returns the summarized aspects corresponding to the plurality of predetermined feedback categories.

In some aspects, the techniques described herein relate to a computer-implemented method, further including limiting the feedback included in the aggregated feedback to feedback meeting predetermined eligibility standards.

In some aspects, the techniques described herein relate to a computer-implemented method, wherein the predetermined eligibility standards include that the feedback included in the aggregated feedback is positive feedback.

In some aspects, the techniques described herein relate to a computer-implemented method, wherein the predetermined eligibility standards include that the feedback provided is within a recency threshold.

In some aspects, the techniques described herein relate to a computer-implemented method, further including, prior to causing the display of the at least one search result or the item listing page to present the one or more feedback signals in association with the seller, determining that a number of feedback entries about the individual seller satisfies a threshold number.

In some aspects, the techniques described herein relate to a computer-implemented method, further including causing the extraction on a periodic basis from a database of the feedback.

In some aspects, the techniques described herein relate to a system including: one or more processors; and memory storing instructions that, when executed by the one or more processors, cause the system to: obtain feedback about a plurality of sellers associated with an online marketplace, the feedback including text reviews; for an individual seller of the plurality of sellers: aggregate the feedback about the individual seller describing interactions with the individual seller on the online marketplace; cause extraction, using a large language model, of keywords from the aggregated feedback about the individual seller; and cause categorization of the extracted keywords into one or more predetermined categories that each summarize an aspect of interacting with individual sellers on the online marketplace; provide, to a computing device, a page of search results including a plurality of items listed on the online marketplace or an item listing page for a particular item listed on the online marketplace, wherein at least one search result on the page of search results or the item listing page corresponds to the individual seller; and cause a display of the at least one search result or the item listing page to present, at the computing device and in association with the individual seller, one or more feedback signals indicating the one or more predetermined categories.

In some aspects, the techniques described herein relate to a system, wherein the instructions further cause the computing device to respond to a selection of the one or more feedback signals by providing on the display the extracted keywords corresponding to the selected one or more feedback signals for the individual seller.

In some aspects, the techniques described herein relate to a system, wherein the instructions further: cause the system to summarize the extracted keywords respectively into the predetermined categories; and cause the computing device to respond to a selection of the one or more feedback signals by providing on the display the predetermined categories corresponding to the selected one or more feedback signals for the individual seller.

In some aspects, the techniques described herein relate to a system, wherein the instructions to cause extraction and cause categorization further cause the system to provide the aggregated feedback for the individual seller and the one or more predetermined categories for which the individual seller is to be rated based on the aggregated feedback to the large language model which returns the summarized aspects corresponding to the plurality of predetermined feedback categories.

In some aspects, the techniques described herein relate to a system, wherein the instructions further cause the system to limit the feedback included in the aggregated feedback to feedback meeting predetermined eligibility standards.

In some aspects, the techniques described herein relate to a system, wherein the predetermined eligibility standards include that the feedback included in the aggregated feedback is positive feedback.

In some aspects, the techniques described herein relate to a system, wherein the predetermined eligibility standards include that the feedback provided within a recency threshold.

In some aspects, the techniques described herein relate to a system, wherein the instructions further cause the system, prior to causing the display of the at least one search result or the item listing page to present the one or more feedback signals in association with the seller, to determine that a number of feedback entries about the individual seller satisfies a threshold number.

In some aspects, the techniques described herein relate to a system, wherein the instructions further cause the system to cause the extraction on a periodic basis from a database of the feedback.

In some aspects, the techniques described herein relate to a non-transitory computer-readable storage medium storing instructions that, when executed by one or more processors, cause the one or more processors to perform operations including: obtaining feedback about a plurality of sellers associated with an online marketplace, the feedback including text reviews; for an individual seller of the plurality of sellers: aggregating the feedback about the individual seller describing interactions with the individual seller on the online marketplace; causing extraction, using a large language model, of keywords from the aggregated feedback about the individual seller; and causing categorization of the extracted keywords into one or more predetermined categories that each summarize an aspect of interacting with individual sellers on the online marketplace; providing, to a computing device, a page of search results including a plurality of items listed on the online marketplace or an item listing page for a particular item listed on the online marketplace, wherein at least one search result on the page of search results or the item listing page corresponds to the individual seller; and causing a display of the at least one search result or the item listing page to present, at the computing device and in association with the individual seller, one or more feedback signals indicating the one or more predetermined categories.

In some aspects, the techniques described herein relate to a non-transitory computer-readable storage medium, further including causing the computing device to respond to a selection of the one or more feedback signals by providing on the display the extracted keywords corresponding to the selected one or more feedback signals for the individual seller.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A computer-implemented method comprising:
obtaining feedback about a plurality of sellers associated with an online marketplace, the feedback comprising text reviews;
for an individual seller of the plurality of sellers:
aggregating the feedback about the individual seller describing interactions with the individual seller on the online marketplace;
causing extraction, using a large language model, of keywords from the aggregated feedback about the individual seller; and
causing categorization of the extracted keywords into one or more predetermined categories that each summarize an aspect of interacting with individual sellers on the online marketplace;
providing, to a computing device, a page of search results including a plurality of items listed on the online marketplace or an item listing page for a particular item listed on the online marketplace, wherein at least one search result on the page of search results or the item listing page corresponds to the individual seller;
causing a display of the at least one search result or the item listing page to present, at the computing device and in association with the individual seller, one or more feedback signals indicating the one or more predetermined categories; and
responsive to a selection of a feedback signal of the one or more feedback signals, causing display of one or more excerpts of the text reviews comprising the extracted keywords categorized in the predetermined category indicated by the selected feedback signal.

2. (canceled)

3. The computer-implemented method of claim 1, further comprising:
summarizing the extracted keywords respectively into the predetermined categories; and
causing the computing device to respond to a selection of the one or more feedback signals by providing on the display the predetermined categories corresponding to the selected one or more feedback signals for the individual seller.

4. The computer-implemented method of claim 1, wherein causing extraction and causing categorization include providing the aggregated feedback for the individual seller and the one or more predetermined categories for which the individual seller is to be rated based on the aggregated feedback to the large language model which returns the summarized aspects corresponding to the plurality of predetermined feedback categories.

5. The computer-implemented method of claim 1, further comprising limiting the feedback included in the aggregated feedback to feedback meeting predetermined eligibility standards.

6. The computer-implemented method of claim 5, wherein the predetermined eligibility standards include that the feedback included in the aggregated feedback is positive feedback.

7. The computer-implemented method of claim 5, wherein the predetermined eligibility standards include that the feedback provided is within a recency threshold.

8. The computer-implemented method of claim 1, further comprising, prior to causing the display of the at least one search result or the item listing page to present the one or more feedback signals in association with the seller, determining that a number of feedback entries about the individual seller satisfies a threshold number.

9. The computer-implemented method of claim 1, further comprising causing the extraction on a periodic basis from a database of the feedback.

10. A system comprising:
one or more processors; and
memory storing instructions that, when executed by the one or more processors, cause the system to:
obtain feedback about a plurality of sellers associated with an online marketplace, the feedback comprising text reviews;
for an individual seller of the plurality of sellers:
aggregate the feedback about the individual seller describing interactions with the individual seller on the online marketplace;
cause extraction, using a large language model, of keywords from the aggregated feedback about the individual seller; and
cause categorization of the extracted keywords into one or more predetermined categories that each summarize an aspect of interacting with individual sellers on the online marketplace;
provide, to a computing device, a page of search results including a plurality of items listed on the online marketplace or an item listing page for a particular item listed on the online marketplace, wherein at least one search result on the page of search results or the item listing page corresponds to the individual seller; and
cause a display of the at least one search result or the item listing page to present, at the computing device and in association with the individual seller, one or more feedback signals indicating the one or more predetermined categories; and
responsive to a selection of a feedback signal of the one or more feedback signals, cause display of one or more excerpts of the text reviews comprising the extracted keywords categorized in the predetermined category indicated by the selected feedback signal.

11. (canceled)

12. The system of claim 10, wherein the instructions further:
cause the system to summarize the extracted keywords respectively into the predetermined categories; and
cause the computing device to respond to a selection of the one or more feedback signals by providing on the display the predetermined categories corresponding to the selected one or more feedback signals for the individual seller.

13. The system of claim 10, wherein the instructions to cause extraction and cause categorization further cause the system to provide the aggregated feedback for the individual seller and the one or more predetermined categories for which the individual seller is to be rated based on the aggregated feedback to the large language model which returns the summarized aspects corresponding to the plurality of predetermined feedback categories.

14. The system of claim 10, wherein the instructions further cause the system to limit the feedback included in the aggregated feedback to feedback meeting predetermined eligibility standards.

15. The system of claim 14, wherein the predetermined eligibility standards include that the feedback included in the aggregated feedback is positive feedback.

16. The system of claim 14, wherein the predetermined eligibility standards include that the feedback provided within a recency threshold.

17. The system of claim 10, wherein the instructions further cause the system, prior to causing the display of the at least one search result or the item listing page to present the one or more feedback signals in association with the seller, to determine that a number of feedback entries about the individual seller satisfies a threshold number.

18. The system of claim 10, wherein the instructions further cause the system to cause the extraction on a periodic basis from a database of the feedback.

19. A non-transitory computer-readable storage medium storing instructions that, when executed by one or more processors, cause the one or more processors to perform operations comprising:
obtaining feedback about a plurality of sellers associated with an online marketplace, the feedback comprising text reviews;
for an individual seller of the plurality of sellers:
aggregating the feedback about the individual seller describing interactions with the individual seller on the online marketplace;
causing extraction, using a large language model, of keywords from the aggregated feedback about the individual seller; and
causing categorization of the extracted keywords into one or more predetermined categories that each summarize an aspect of interacting with individual sellers on the online marketplace;
providing, to a computing device, a page of search results including a plurality of items listed on the online marketplace or an item listing page for a particular item listed on the online marketplace, wherein at least one search result on the page of search results or the item listing page corresponds to the individual seller;
causing a display of the at least one search result or the item listing page to present, at the computing device and in association with the individual seller, one or more feedback signals indicating the one or more predetermined categories; and
responsive to a selection of a feedback signal of the one or more feedback signals, causing display of one or more excerpts of the text reviews comprising the extracted keywords categorized in the predetermined category indicated by the selected feedback signal.

20. (canceled)

21. The computer-implemented method of claim 1, wherein the one or more feedback signals and the one or more excerpts of the text reviews are displayed within a user interface that presents the at least one search result or the item listing page.

22. The computer-implemented method of claim 1, wherein the selection of the feedback signal comprises a hover, tap, or click input on the feedback signal, and wherein causing display of the one or more excerpts of the text reviews includes displaying the one or more excerpts in a popup within a user interface that presents the at least one search result or the item listing page.

23. The computer-implemented method of claim 1, wherein causing display of the one or more excerpts of the text reviews further includes displaying a frequency or a recency of the feedback corresponding to the predetermined category indicated by the selected feedback signal.
